(19) United States
(12) Patent Application Publication
(10) Pub. No.: US 2025/0191869 A1
(43) Pub. Date: Jun. 12, 2025

(54) FUSE WITH CAST ARC SUPPRESSING MATERIALS FOR IMPROVED BREAKING CAPACITY

(71) Applicant: Littelfuse, Inc., Chicago, IL (US)

(72) Inventors: Oluwaseun Oyewole, Fremont, CA (US); Marco Doms, Berlin (DE); Arjuna Shenoy, San Jose, CA (US); Martin Pineda, Fremont, CA (US); Claran Martis, Sunnyvale, CA (US)

(73) Assignee: Littelfuse, Inc., Chicago, IL (US)

(21) Appl. No.: 18/939,638

(22) Filed: Nov. 7, 2024

Related U.S. Application Data
(60) Provisional application No. 63/607,770, filed on Dec. 8, 2023.

(51) Int. Cl. H01H 85/38

(52) U.S. Cl. CPC H01H 85/38; H01H 2085/388

(57) ABSTRACT

A fuse including a fuse body, a fusible element disposed within the fuse body, first and second terminals extending from opposite ends of the fusible element and out of the fuse body, and a quantity of arc suppressing material formed on the fusible element, wherein the arc suppressing material is formed of a mixture of sand, an arc suppressant, and a flame retarding binder.

### CROSS-REFERENCES TO RELATED APPLICATIONS

This application claims the benefit of U.S. Provisional Patent Application No. 63/607,770, filed Dec. 8, 2023, which is incorporated by reference herein in its entirety.

### FIELD OF THE DISCLOSURE

The present disclosure relates generally to the field of circuit protection devices and relates more particularly to a high breaking capacity fuse with arc-mitigating features.

### BACKGROUND OF THE DISCLOSURE

Fuses are commonly used as circuit protection devices and are typically installed between a source of electrical power and a component in a circuit that is to be protected. Generally, a fuse includes a fusible element disposed within an electrically insulating fuse body. Electrically conductive terminals extend from opposing ends of the fusible element for facilitating electrical connection of the fuse within a circuit. Upon the occurrence of an overcurrent condition in the circuit, the fusible element melts or otherwise opens to arrest the flow of electrical current through the fuse, thereby protecting connected electrical components.

When the fusible element of a fuse is melted during an overcurrent condition it is sometimes possible for an electrical arc to propagate between the separated portions of the fusible element (e.g., through vaporized particulate from the melted fusible element). The electrical arc may rapidly heat the surrounding air and ambient particulate and may cause a small explosion within the fuse. In some cases, the explosion may rupture the fuse body, potentially causing damage to surrounding components. The likelihood of rupture is generally proportional to the severity of the overcurrent condition. The maximum current that a fuse can arrest without rupturing is referred to as the fuse's “breaking capacity.” It is generally desirable to maximize the breaking capacity of a fuse without significantly increasing the cost, size, or form factor of the fuse.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A fuse in accordance with an embodiment of the present disclosure may include a fuse body, a fusible element disposed within the fuse body, first and second terminals extending from opposite ends of the fusible element and out of the fuse body, and a quantity of arc suppressing material formed on the fusible element, wherein the arc suppressing material is formed of a mixture of sand, an arc suppressant, and a flame retarding binder.

A fuse in accordance with another embodiment of the present disclosure may include a fuse body, a fusible element disposed within the fuse body, first and second terminals extending from opposite ends of the fusible element and out of the fuse body, a first puck formed of an arc suppressing material disposed on a first side of the fusible element, and a second puck formed of the arc suppressing material disposed on a second side of the fusible element opposite the first side, wherein the arc suppressing material is formed of a mixture of sand, an arc suppressant, and a flame retarding binder.

### BRIEF DESCRIPTION OF THE DRAWINGS

FIG. 1 is a perspective view illustrating a fuse in accordance with an exemplary embodiment of the present disclosure;

FIG. 2 is a cross-sectional side view illustrating the fuse of FIG. 1;

FIG. 3A is a top view illustrating a fuse assembly of the fuse of FIG. 1 in an untripped state;

FIG. 3B is a side view illustrating a fuse assembly of the fuse of FIG. 1 in an untripped state;

FIG. 4A is a top view illustrating a fuse assembly of the fuse of FIG. 1 in a tripped state;

FIG. 4B is a side view illustrating a fuse assembly of the fuse of FIG. 1 in a tripped state;

FIG. 5A is a top view illustrating a fuse assembly in accordance with another embodiment of the present disclosure;

FIG. 5B is a top view illustrating the fuse assembly of FIG. 5A disposed within a fuse body of a cartridge fuse;

FIGS. 6A-6D are a series of top views illustrating a method of assembling a surface mount fuse in accordance with an embodiment of the present disclosure.

The drawings are not necessarily to scale. The drawings are merely representations, not intended to portray specific parameters of the disclosure. The drawings are intended to depict example embodiments of the disclosure, and thus are not to be considered as limiting in scope. In the drawings, like numbering represents like elements.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DETAILED DESCRIPTION

A fuse in accordance with the present disclosure will now be described more fully hereinafter with reference to the accompanying drawings, in which certain exemplary embodiments of the fuse are presented. The fuse may be embodied in many different forms and is not to be construed as being limited to the embodiments set forth herein. These embodiments are provided so that this disclosure will be thorough and complete, and will fully convey the scope of the fuse to those skilled in the art. In the drawings, like numbers refer to like elements throughout unless otherwise noted.

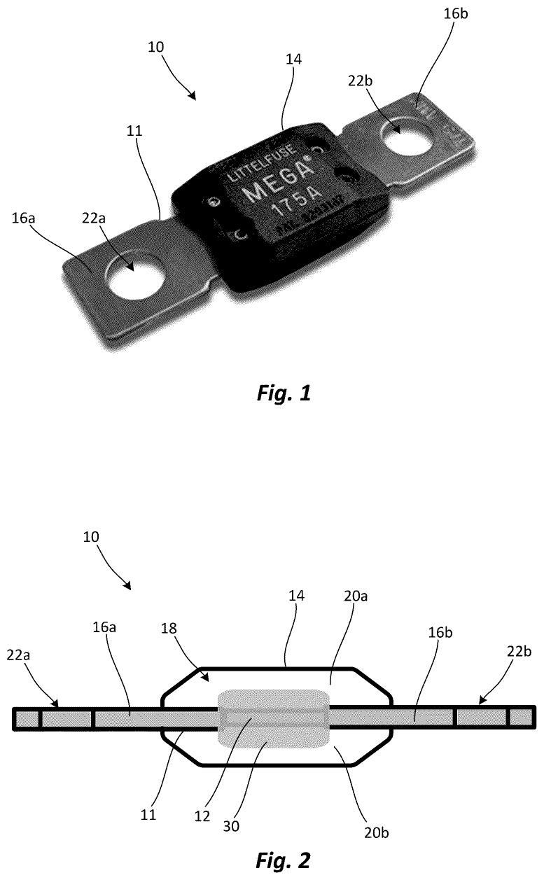

Referring to FIGS. 1 and 2, a perspective view and a cross sectional side view illustrating a fuse 10 in accordance with an exemplary embodiment of the present disclosure are provided, respectively. For the sake of convenience and clarity, terms such as “top,” “bottom,” “up,” “down,” “upper,” “lower,” “above,” and “below” may be used herein to describe the relative positions and orientations of various components of the fuse 10, all with respect to the geometry and orientation of the fuse 10 as it appears in FIGS. 1 and 2. Said terminology will include the words specifically mentioned, derivatives thereof, and words of similar import.

The fuse 10 may generally include an electrically conductive fuse assembly 11 partially disposed within an electrically insulating fuse body 14. The fuse assembly 11 may include a fusible element 12, and first and second terminals 16a, 16b extending from opposite ends of the fusible element 12 and out of the fuse body 14. The fusible element 12 and the first and second terminals 16a, 16b may be made from any of a variety of electrically conductive materials, including, but not limited to, copper, tin, silver, zinc, aluminum, alloys including such materials, or combinations thereof. The fuse body 14 may be formed of any suitable dielectric material, including, but not limited to, plastic, ceramic, various composites, etc. The fuse assembly 11 may be formed using any of a variety of techniques, including, but not limited to, stamping, cutting, and printing, and can include forming the fusible element 12 and the first and second terminals 16a, 16b separately or as one piece (e.g., stamped or cut from a single sheet or plate of metal). If the fusible element 12 and the first and second terminals 16a, 16b are formed separately (i.e., in separate pieces), the pieces may subsequently be joined together using various techniques, including, for example, soldering, welding, or other known joining processes.

In various embodiments, the fuse body 14 may include a plurality of segments or parts that are joined together to define a cavity 18 within which the fusible element 12 is disposed. For example, the fuse body 14 may include upper and lower segments 20a, 20b that may be joined together (e.g., via, heat staking, riveting, ultrasonic welding, etc.) to form a contiguous, substantially sealed body that protects the fusible element 12 from external elements. The first and second terminals 16a, 16b may protrude from the fuse body 14 and may facilitate electrical connection of the fuse 10 within a circuit. For example, the first and second terminals 16a, 16b may include respective first and second mounting holes 22a, 22b formed therein for receiving bolts or posts (now shown) for connecting the fuse 10 to a source of electrical power (e.g., a battery) and to a load.

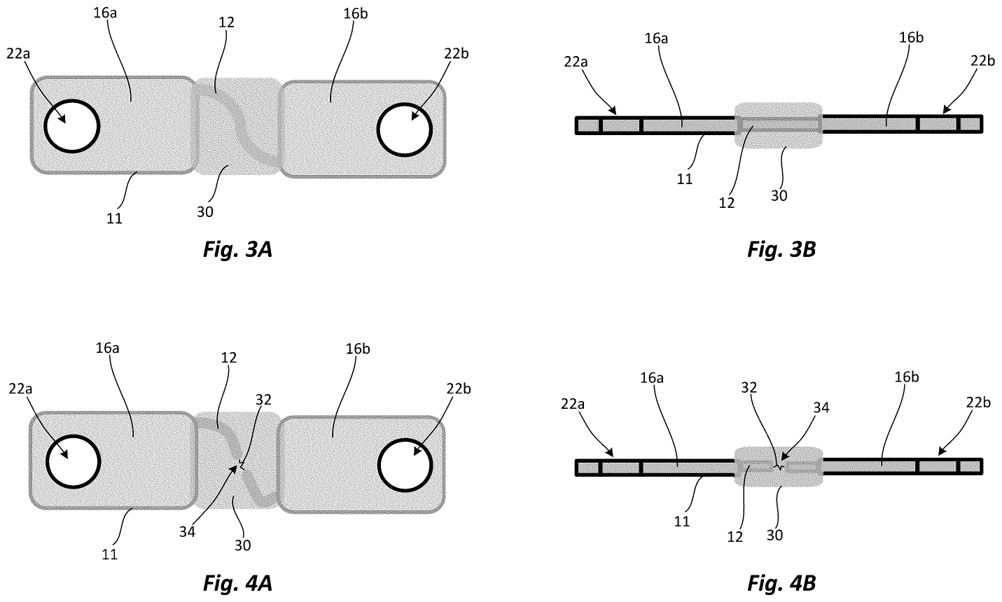

Referring to FIGS. 3A and 3B, a top view and a side view illustrating the fusible element 12 and the first and second terminals 16a, 16b of the fuse 10 are shown (the fuse body 14 is omitted for clarity). The fusible element 12 may be configured to melt, disintegrate, or otherwise open if current flowing through the fuse 10 exceeds a predetermined threshold, or “current rating,” of the fuse 10. In certain embodiments, the fusible element 12 may have a serpentine shape as shown in FIG. 3A. The present disclosure is not limited in this regard. In various embodiments, the fusible element 12 may include perforations, slots, thinned or narrowed segments, and/or various other features for making certain portions of the fusible element 12 more susceptible to melting or opening relative to other portions of the fusible element 12.

The fuse 10 may further include a quantity of arc suppressing material 30 disposed on the fuse assembly 11, conformally coating and covering the fusible element 12 and adjacent portions of the first and second terminals 16a, 16b in intimate contact therewith. The arc suppressing material 30 may be a mixture of sand, an arc suppressant, and a flame retarding binder. In various examples, the arc suppressant may be melamine or cyanuric acid and the flame retarding binder may be a silicone-based material such as polydimethylsiloxane (PDMS). The arc suppressant may be provided in an amount of 5.00% to 12.00% by weight of the arc suppressing material 30, and the flame retarding binder may be provided in an amount of 3.00% to 6.00% by weight of the arc suppressing material 30. The present disclosure is not limited in this regard.

During manufacture of the fuse 10, the arc suppressing material 30 may be cast directly onto the fusible element 12 and adjacent portions of the first and second terminals 16a, 16b using any suitable casting process.

Upon the occurrence of an overcurrent condition in the fuse 10, the fusible element 12 may melt and separate, and an electrical arc 32 may propagate across a gap 34 left between the separated ends of the fusible element 12 as shown in FIGS. 4A and 4B. Heat from the electrical arc 32 may melt the arc suppressing material 30 which, in a fluid state, may then flow into the gap 34 and quench the electrical arc 32. Heat from the electrical arc 32 may also burn/decompose the arc suppressing material 30, causing the arc suppressing material 30 to undergo an endothermic chemical reaction that absorbs heat. The electrical arc 32 is thereby rapidly cooled. Furthermore, certain byproducts of the endothermic chemical reaction may be nonconductive gases (e.g., ammonia) that may hinder the ability of the electrical arc 32 to persist. Thus, the arc suppressing material 30 may, upon the occurrence of an electrical overcurrent condition in the fuse 10, absorb heat and release gases that are unfavorable to sustaining an electrical arc. The duration and severity of electrical arcing within the fuse 10 is thereby mitigated, which in-turn provides the fuse 10 with an improved breaking capacity relative to traditional fuses.

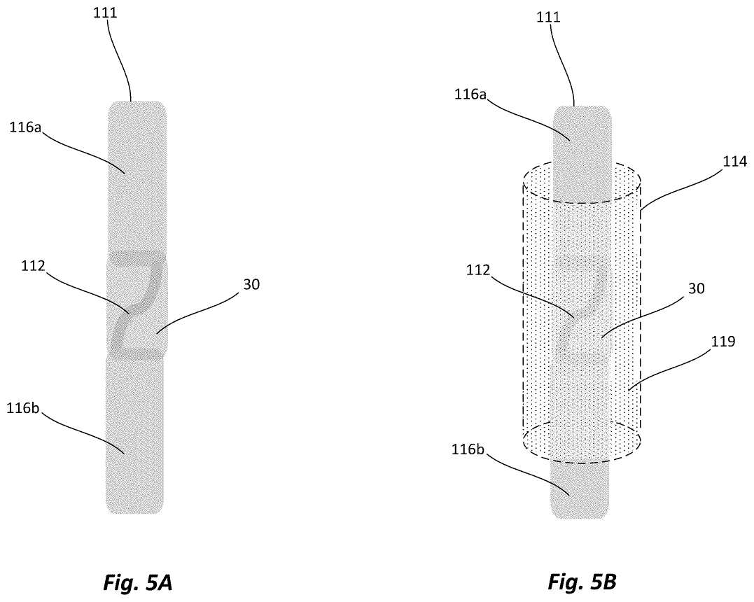

The arc suppressing material 30 implemented in the fuse 10 described above may be similarly implemented in various other types of fuse configurations. For example, referring to FIG. 5A, an embodiment of the present disclosure is shown wherein the arc suppressing material 30 may be cast directly onto a fuse assembly 111 adapted for use in a cartridge fuse. Particularly, the arc suppressing material 30 may be cast onto a fusible element 112 and adjacent portions of first and second terminals 116a, 116b of the fuse assembly 111. Referring to FIG. 5B, the fuse assembly 111 may be inserted into a fuse body 114, and the fuse body 114 may be filled with a quantity of sand or other arc quenching filler 119 that surrounds the fusible element 112.

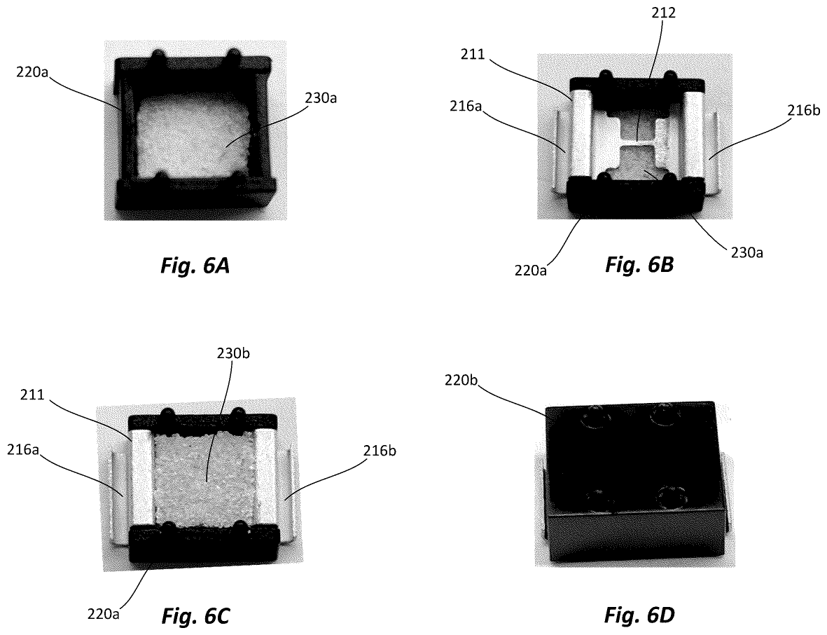

Referring to FIGS. 6A-6D, another embodiment of the present disclosure is shown, wherein the above-described arc suppressing material 30 is implemented in a surface mount fuse that includes a fuse assembly 211 disposed within a base 220a of a fuse body, and a cap 220b disposed over the fuse assembly 211 and fastened to the base 220a (e.g., via, heat staking, riveting, ultrasonic welding, etc.). Unlike the embodiments described above, the arc suppressing material 30 is not cast directly onto the fuse assembly 211. Rather, the arc suppressing material 30 may be pre-cast into first and second segments or pucks 230a, 230b that surround or sandwich a fusible element 212 of the fuse assembly 211. For example, referring to FIG. 6A, a first step in a process of assembling the surface mount fuse is shown, wherein the first puck 230a of arc suppressing material 30 is placed within the base 220a of the fuse body. Referring to FIG. 6B, the fuse assembly 211 is then placed in the base 220a, with the fusible element 212 disposed atop the first puck 230a and with first and second terminals 216a, 216b of the fuse assembly 211 extending out of the base 220a. Referring to FIG. 6C, the second puck 230b of arc suppressing material 30 may be disposed atop the fusible element 212. In various embodiments, and as best shown in FIG. 6B, the first and second terminals 216a, 216b may be formed or bent to define a cradle for receiving and holding the second puck 230b. Referring to FIG. 6D, the cap 220b may be fastened to the base 220a to enclose the fusible element 212 and the first and second pucks 230a, 230b.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A fuse comprising:
a fuse body;
a fusible element disposed within the fuse body;
first and second terminals extending from opposite ends of the fusible element and out of the fuse body; and
a quantity of arc suppressing material formed on the fusible element, wherein the arc suppressing material is formed of a mixture of sand, an arc suppressant, and a flame retarding binder.

2. The fuse of claim 1, wherein the arc suppressant is one of melamine and cyanuric acid.

3. The fuse of claim 1, wherein the flame retarding binder is a silicone-based material.

4. The fuse of claim 3, wherein the flame retarding binder is polydimethylsiloxane.

5. The fuse of claim 1, wherein the arc suppressing material is cast directly onto the fusible element.

6. The fuse of claim 1, wherein the fuse body is filled with an arc quenching material that surrounds the fusible element and the arc suppressing material.

7. The fuse of claim 6, wherein the arc quenching material is sand.

8. The fuse of claim 1, wherein the fusible element and the first and second terminals are formed from a single piece of material.

9. A fuse comprising:
a fuse body;
a fusible element disposed within the fuse body;
first and second terminals extending from opposite ends of the fusible element and out of the fuse body;
a first puck formed of an arc suppressing material disposed on a first side of the fusible element; and
a second puck formed of the arc suppressing material disposed on a second side of the fusible element opposite the first side;
wherein the arc suppressing material is formed of a mixture of sand, an arc suppressant, and a flame retarding binder.

10. The fuse of claim 9, wherein the arc suppressant is one of melamine and cyanuric acid.

11. The fuse of claim 9, wherein the flame retarding binder is a silicone-based material.

12. The fuse of claim 11, wherein the flame retarding binder is polydimethylsiloxane.

13. The fuse of claim 9, wherein the first and second terminals are bent to define a cradle for receiving at least one of the first puck and the second puck.

14. The fuse of claim 9, wherein the fuse is a surface mount fuse.

15. The fuse of claim 9, wherein the first puck and the second puck are pre-cast elements.

16. The fuse of claim 9, wherein the fusible element and the first and second terminals are formed from a single piece of material.
